(19) United States
(12) Patent Application Publication
(10) Pub. No.: US 2025/0026082 A1
(43) Pub. Date: Jan. 23, 2025

(54) ULTRASONIC WELDING OF AN INSULATING RECEPTACLE

(71) Applicant: Scribe OpCo, Inc., dba BIC Graphic, Clearwater, FL (US)

(72) Inventors: Steve Rosato, Palm Harbor, FL (US); Keith Dugal, Largo, FL (US)

(21) Appl. No.: 18/776,475

(22) Filed: Jul. 18, 2024

Related U.S. Application Data
(60) Provisional application No. 63/514,261, filed on Jul. 18, 2023.

(51) Int. Cl. B29C 65/08; B29C 65/78; B29L 23/00; B65D 81/38

(52) U.S. Cl. CPC B29C 65/08; B29C 65/7867; B29L 2023/001; B65D 81/3876

(57) ABSTRACT

A joining method for an insulating receptacle and the insulating receptacle produced therefrom are disclosed. The method of the present disclosure is an ultrasonic welding process utilizing an ultrasonic welder to join edges of a blank together by welded seams. The welded seams have a relatively low profile and/or present less impediment, resulting in easier insertion of a beverage container into the receptacle. The ultrasonic welder includes a fixture and a drive system having a welding horn. The fixture and/or the welding horn includes one or more engagement/welding elements having one or more protuberances (i.e., “weld points”) formed thereon.

### CROSS-REFERENCE TO RELATED APPLICATION

This application claims the benefit of U.S. Provisional Patent Application Ser. No. 63/514,261, filed Jul. 18, 2023, the entirety of which is herein incorporated by reference.

### FIELD

The disclosure relates to an insulating receptacle for beverage containers, and more particularly to ultrasonic welding of an insulating receptacle and the same produced therefrom.

### BACKGROUND

As commonly known, various types of receptacles, such as sleeves or jackets, are employed to insulate beverage containers, militate against condensation forming on an outer surface of the beverage containers, provide a surface for promotional or identifying indicia, and/or act as a barrier between the beverage container and a hand of a holder of the beverage container. For example, receptacles are often used to receive carbonated beverage containers such as aluminum cans typically employed to contain water, soda, beer, or similar types of beverages.

However, conventional manufacturing of the receptacle is undesirably complex and costly. Typically, one or more seams of the receptacle are produced by a sewing process. Although the sewn seams are very strong, a sewing process is a manual sewing process is labor intensive, slow, and inconsistent width between seams. Moreover, the sewing process can be expensive with the cost of consumables (e.g., thread and needles) with significant maintenance costs (e.g., labor and parts). For example, the sewing process takes about three (3.0) seconds per seam and about six (6.0) seconds per receptacle, which results in a total cycle time of about five (5.0) seconds per seam and about ten (10) seconds per receptacle.

Therefore, it would be desirable to develop a method of manufacturing an insulating receptacle that simple and cost efficient, yet produces an effective and durable insulating receptacle.

### SUMMARY

In concordance and agreement with the presently described subject matter, a method of manufacturing an insulating receptacle that simple and cost efficient, while producing an effective and durable insulating receptacle, has been surprisingly developed.

In an embodiment, a method of manufacturing an insulating receptacle, comprises: providing a blank from one or more materials; and ultrasonic welding the blank to form the insulating receptacle.

As aspects of some embodiments, the method further comprises disposing an indicia on the blank prior to the ultrasonic welding of the blank.

As aspects of some embodiments, the blank is formed from at least one of a polyester weave material, a neoprene material, a foam material, a flexible material, a stretchy material, a liquid proof material, a liquid resistant material, and/or blends thereof.

As aspects of some embodiments, the blank includes a plurality of sides, each of the sides having one or more opposing edges.

As aspects of some embodiments, the method further comprises aligning an edge of one of the sides and an edge of another one of the sides prior to the ultrasonic welding of the blank.

As aspects of some embodiments, the ultrasonic welding occurs adjacent the edges of the sides to join the sides together.

As aspects of some embodiments, the ultrasonic welding of the blank is by a welding machine, wherein the welding machine includes a fixture and a drive system having a welding horn.

As aspects of some embodiments, the fixture and/or the welding horn includes one or more engagement/welding elements.

As aspects of some embodiments, the one or more engagement/welding elements of the fixture include one or more protuberances formed thereon.

As aspects of some embodiments, a distance between each of the protuberances is about 2.5 mm.

As aspects of some embodiments, the one or more protuberance is a plurality of teeth formed on the one or more engagement/welding elements of the fixture.

As aspects of some embodiments, the one or more engagement/welding elements of the welding horn include one or more protuberances formed thereon.

As aspects of some embodiments, a distance between each of the protuberances is about 2.5 mm.

As aspects of some embodiments, the one or more protuberance is a plurality of teeth formed on the one or more engagement/welding elements of the fixture.

As aspects of some embodiments, the method further comprises transporting the blank by a carrier shuttle.

As aspects of some embodiments, the ultrasonic welding has a total cycle time of about three seconds per insulating receptacle.

In another embodiment, a method of manufacturing an insulating receptacle, comprises: providing a blank from one or more materials, wherein the blank includes opposing sides having one or more edges; folding the blank to align the one or more edges of the sides; disposing the folded blank into a carrier shuttle; transporting the folded blank to a welding machine; ultrasonic welding the folded blank adjacent the edges of the sides to form the insulating receptacle; and transporting the welded blank from the welding machine.

As aspects of some embodiments, the method further comprises disposing an indicia on the blank prior to transporting the folded blank to the welding machine.

As aspects of some embodiments, an insulating receptacle, comprises: a blank comprising at least one piece of material having opposing sides, wherein each of the sides includes one or more edges; and an ultrasonic-welded seam adjacent each of the edges to form the insulating receptacle.

As aspects of some embodiments, an indicia is provided on the blank.

Further areas of applicability will become apparent from the description provided herein. The description and specific examples in this summary are intended for purposes of illustration only and are not intended to limit the scope of the present disclosure.

### BRIEF DESCRIPTION OF DRAWINGS

The drawings described herein are for illustrative purposes only of selected embodiments and not all possible implementations, and are not intended to limit the scope of the present disclosure.

FIG. 1 is a perspective view showing a prior art insulating receptacle formed by a conventional sewing process, wherein a beverage container is disposed in the insulating receptacle;

FIG. 2 is a perspective view of the prior art insulating receptacle of FIG. 1, wherein the insulating receptacle is inverted to show an interior thereof;

FIG. 3 is a perspective view of an insulating receptacle formed by an ultrasonic welding process according to an embodiment of the present disclosure, wherein a beverage container is disposed in the insulating receptacle;

FIG. 4 is a perspective view of the insulating receptacle of FIG. 3, wherein the insulating receptacle is inverted to show an interior thereof;

FIG. 5 is top plan view of a blank used in manufacturing the insulating receptacle of FIGS. 3 and 4;

FIG. 6 is a front perspective view of an exemplary ultrasonic welder used to produce the insulting receptacle shown in FIGS. 3 and 4;

FIG. 7 is a rear perspective view of the ultrasonic welder shown in FIG. 6;

FIG. 8 is a front elevational view of the ultrasonic welder shown in FIGS. 6 and 7;

FIG. 9 is a rear elevational view of the ultrasonic welder shown in FIGS. 6-8;

FIG. 10 is a left side elevational view of the ultrasonic welder shown in FIGS. 6-9;

FIG. 11 is a right side elevational view of the ultrasonic welder shown in FIGS. 6-10;

FIG. 12 is a top plan view of the ultrasonic welder shown in FIGS. 6-11;

FIG. 13 is a bottom plan view of the ultrasonic welder shown in FIGS. 6-12;

FIG. 14 is an enlarged fragmentary perspective view of a portion of the ultrasonic welder shown in FIGS. 6-13;

FIG. 15 is an enlarged fragmentary perspective view of an alternative welding horn for the ultrasonic welder shown in FIGS. 6-13; and

FIG. 16 is a fragmentary perspective view of an exemplary production line incorporating the ultrasonic welder shown in FIGS. 6-13, wherein a protective enclosure has been added to the ultrasonic welder.

### DETAILED DESCRIPTION

The following description of technology is merely exemplary in nature of the subject matter, manufacture and use of one or more present disclosures, and is not intended to limit the scope, application, or uses of any specific present disclosure claimed in this application or in such other applications as may be filed claiming priority to this application, or patents issuing therefrom. Regarding methods disclosed, the order of the steps presented is exemplary in nature, and thus, the order of the steps can be different in various embodiments. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, all compositional percentages are by weight of the total composition, unless otherwise specified. Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

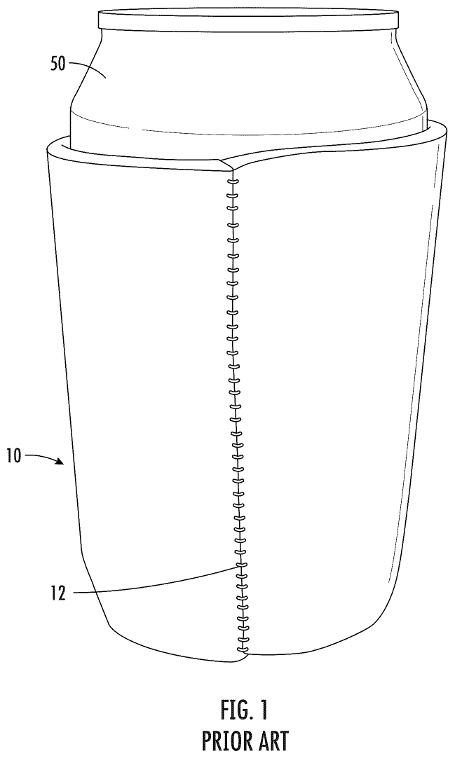

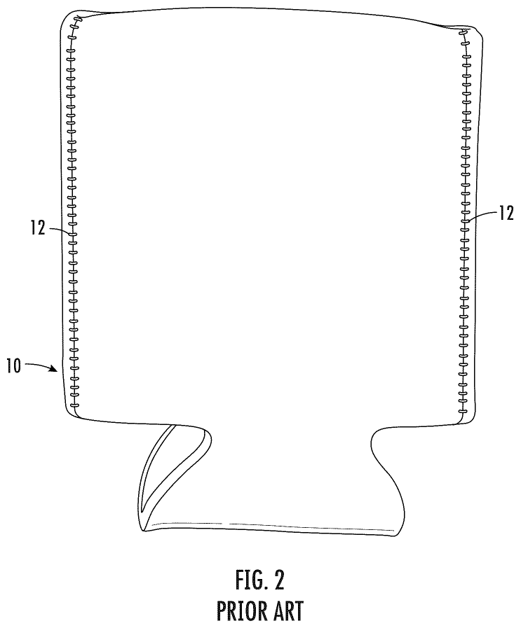

FIGS. 1 and 2 show a prior art insulating receptacle 10 produced from a conventional sewing process. As shown in FIG. 1, a container 50 such as a beverage container may be received in the receptacle 10. The sewing process used to produce the receptacle 10 is undesirably complex and costly. Typically, the receptacle 10 is formed with one or more sewn seams 12. Although the sewn seams 12 may be strong, the sewing process is primarily a manual operation which is labor intensive, slow, and may produce inconsistent widths between seams. For example, the sewing process takes about three (3.0) seconds per sewn seam 12 and about six (6.0) seconds per receptacle 10, which results in a total cycle time of about five (5.0) seconds per sewn seam 12 and about ten (10.0) seconds per receptacle 10. Moreover, the sewing process can be expensive with the cost of consumables (e.g., thread and needles) and significant maintenance costs (e.g., labor and parts).

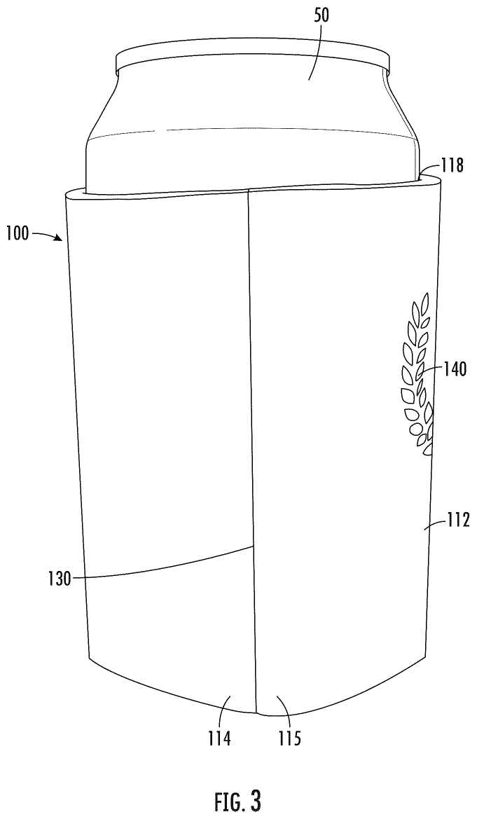

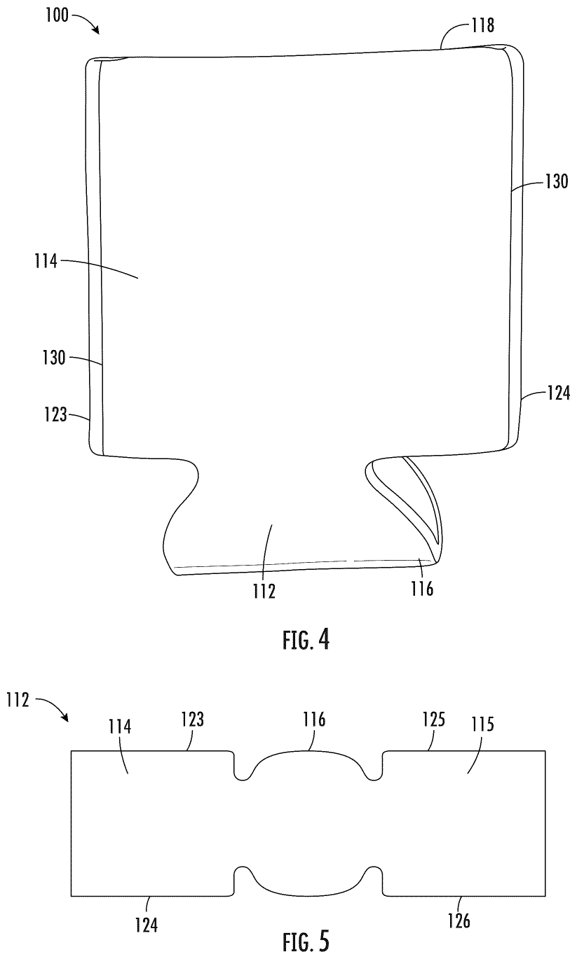

FIGS. 3 and 4 show an insulating receptacle 100 according to an embodiment of the disclosure. The receptacle 100 can be positioned between an open position as shown in FIG. 3 and a collapsed position as shown in FIG. 4, but not inverted as is depicted. The receptacle 100 may comprise a single continuous blank 112 (as depicted in FIG. 5) formed from a piece of material. As used herein, continuous means without interruption, an unbroken whole, or seamless. In the example illustrated, the blank 112 may be formed from a single unitary piece of material and not multiple pieces of material joined together. However, it is understood the blank 112 may be formed from multiple portions of one or more materials integrated or coupled together with each other. The blank 112 may be formed from any suitable material as desired. In some embodiments, the blank 112 may be formed from a polyester weave material. It is understood, however, that the blank 112 may be formed from various other materials with a multitude of properties such as a neoprene material, a foam material, a flexible material, a stretchy material, a liquid proof or liquid resistant material, and the like, or any combination thereof, for example. Various thicknesses of material may also be used for the blank 112.

As best seen in FIG. 5, the blank 112 includes a pair of sides 114, 115 and a bottom 116 continuously formed with each other. The blank 112 includes an opening 118 opposite the bottom 116. The bottom 116 is substantially linear extending between the sides 114, 115 when in the open position, wherein the sides 114, 115 extend from an outer perimeter of the bottom 116. Edges 123, 124 of the side 114 abut and are coupled to respective edges 125, 126 of the side 115. In the collapsed position, the bottom 116 folds upon itself to move the sides 114, 115 towards each other. In the open position, the bottom 116 and the sides 114, 115 define a chamber (not depicted) in communication with the opening 118. As shown in FIG. 3, the container 50 may be received through the opening 118 of the receptacle 100 into the chamber.

In some embodiments, one or more of the sides 114, 115 may include indicia 140 formed thereon. The indicia 140 can be any color, shape, letter, advertisement, logo, or combination thereof. The indicia 140 may be applied by a printing process such as laser printing, screen printing, ink jet printing, or the like. Although, the indicia 140 can be disposed on the blank 112 by any other application or forming process as desired.

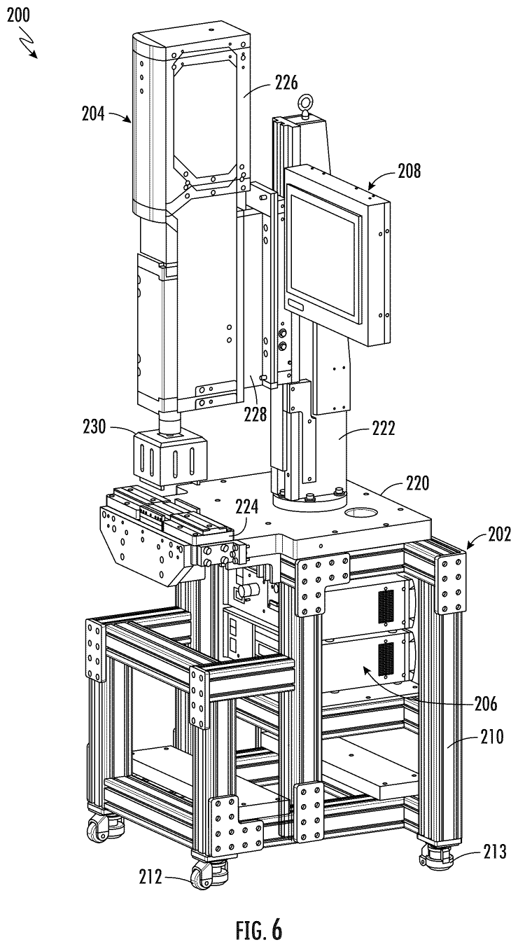

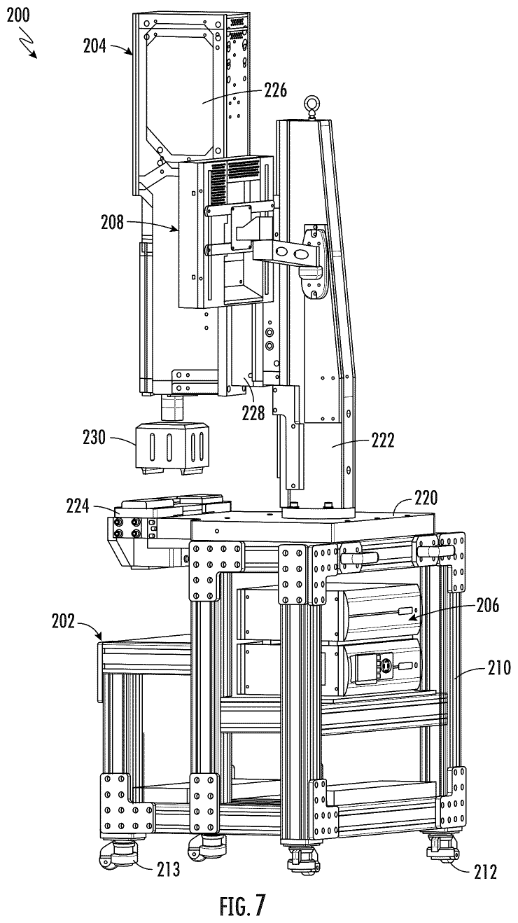

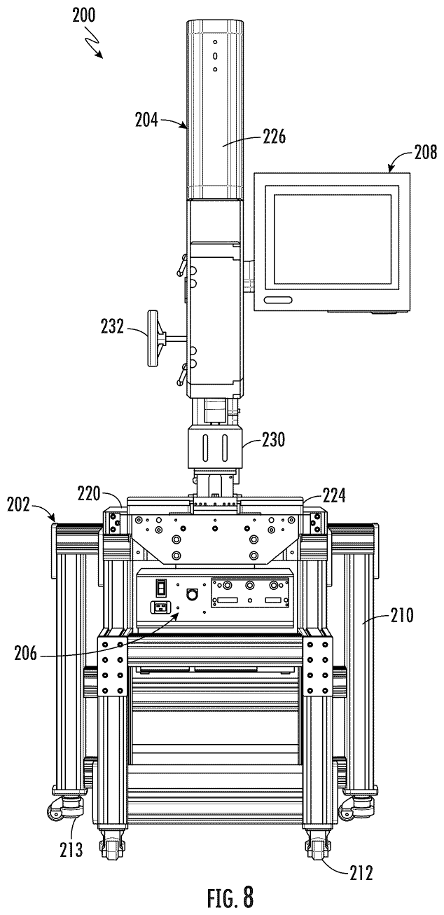

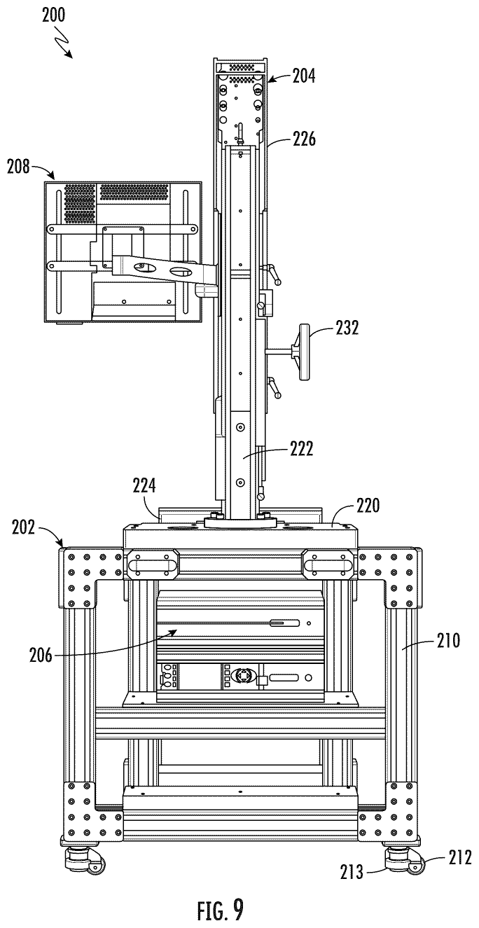

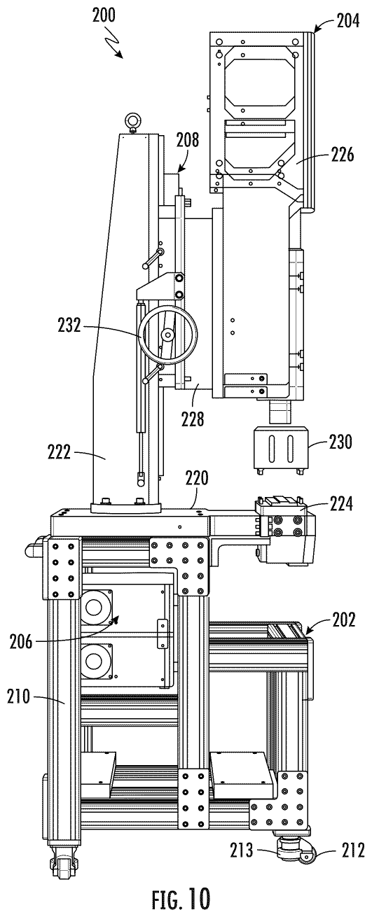

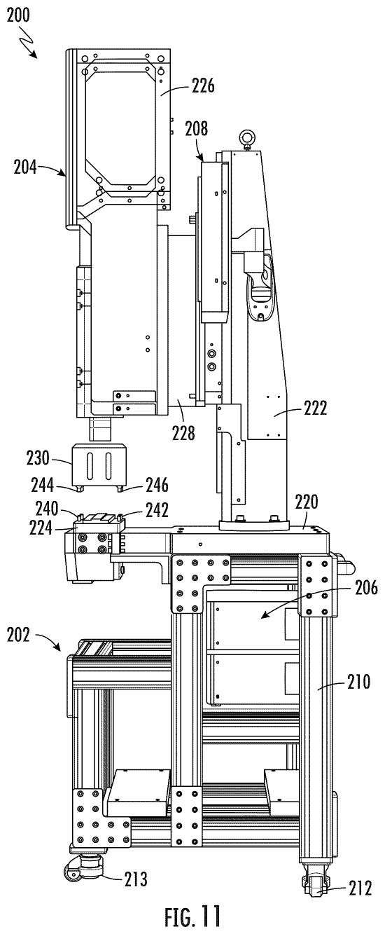

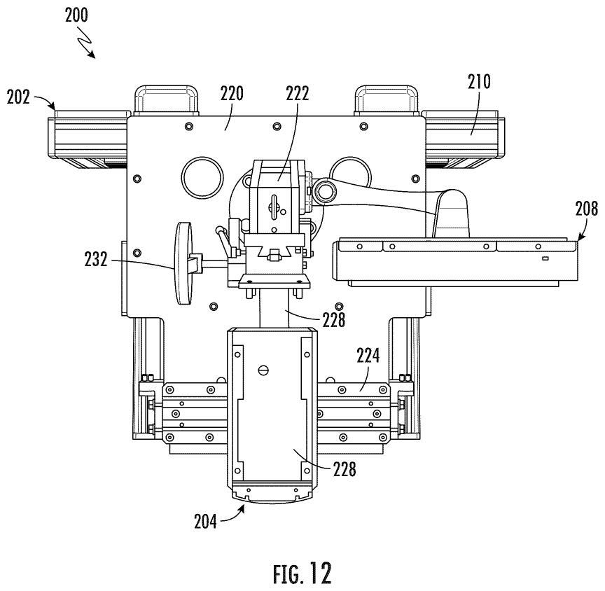

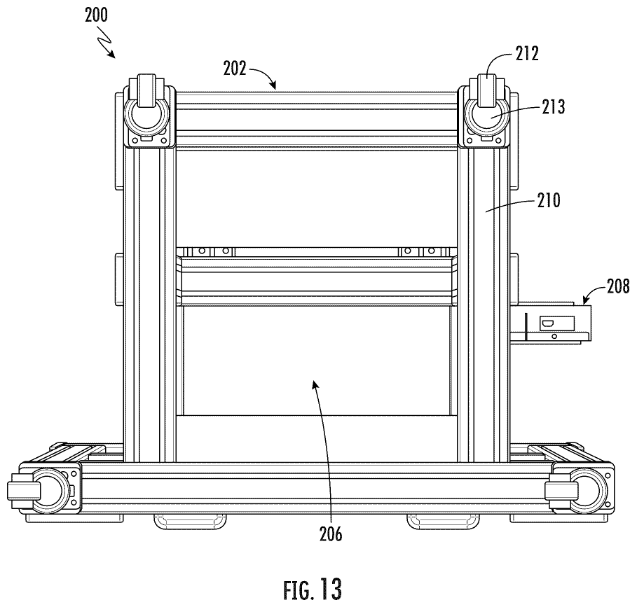

To manufacture the receptacle 100, the blank 112 can be flat. This permits easy printing of the blank 112 before further processing. Once the printing of the indicia 140 has been completed, if desired, the blank 112 proceeds to a joining process utilizing a joining system to be formed into the receptacle 100. Preferably, the receptacle 100 may be formed by an ultrasonic welding process utilizing an ultrasonic welder 200 (depicted in FIGS. 6-16). The ultrasonic welding process may use ultrasonic energy at relatively high frequencies (e.g., 20-40 kHz) to produce relatively low amplitude (e.g., 1-25 μm) mechanical vibrations. The ultrasonic welding process may also be utilized for producing insulating receptacles configured for beverage bottles as well, eliminating a need for a zipper.

FIGS. 6-15 shown an embodiment of the ultrasonic welder 200 in accordance with the present disclosure. The welder 200 comprises a base 202, a welding machine 204 supported by the base 202, at least one controller 206 in communication with the welding machine 204, and a user interface 208 in communication with the at least one controller 206. The at least one controller 206 may be configured to control the welding machine 204 and delivery of the ultrasonic energy. A user (not depicted) may use the user interface 208 to communicate with the at least one controller 206. For example, the user interface 208 may be used by the user to input, receive, and/or view applications, codes, instructions, controls, and the like.

As illustrated, the base 202 comprising a plurality of members 210 coupled together to form a support structure for the welding machine 204. Each of the members 210 may be produced from a rigid material such as an extruded aluminum, for example. However, it should be appreciated that the base 202 may be comprise any shape, size, and configuration of members 210 and be formed from any suitable material as desired. One or more movable elements 212 (e.g., wheels) may be disposed on a bottom of the base 202 to facilitate movement and positioning of the welder 200 at a desired location. It is also understood that various other types of bases 202, movable elements 212, and/or base supports 213 (e.g. feet) may be employed to support and move the welding machine 204. In some embodiments, the bases 202 may also be configured to support the at least one controller 206. It is understood that the at least one controller 206 may be located elsewhere if desired.

Turning now to the welding machine 204. In some embodiments, the welding machine 204 comprises a baseplate 220 having a column 222 extending substantially perpendicular thereto, a fixture 224 coupled to the baseplate 220, and a drive system 226 movably coupled to the column 222 by a carriage 228. It is appreciated that the baseplate 220 and/or the fixture 224 may comprise an “anvil” of the welding machine 204. It should also be appreciated that the drive system 226 may include a welding horn 230, a sonotrode (not depicted), a booster (not depicted), a transducer/converter (not depicted), and a drive assembly (not depicted) configured to cause the drive system 226 and carriage 228 to move along the column 222. In some embodiments, the drive assembly may be a pneumatic or hydraulic assembly, or a hybrid thereof, comprising at least one pneumatic or hydraulic cylinder with a piston disposed therein. It is understood that the drive assembly may be any means or method to cause movement of the drive system 226. For example, the drive system 226 may be an electric drive system. The drive system 226 may further include an actuator 232 for manually moving the drive system 226 and carriage 228 along the column 222.

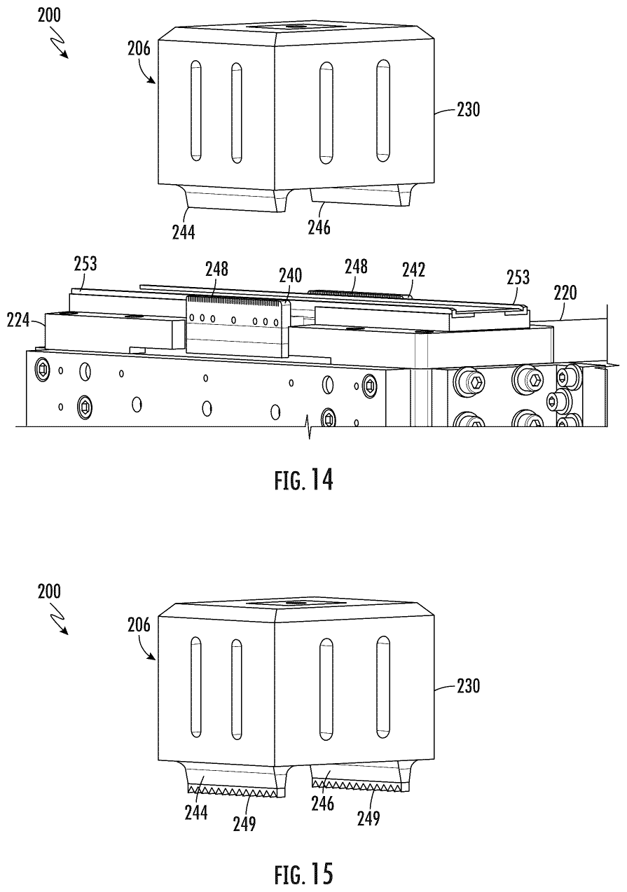

As best seen in FIGS. 14 and 15, the fixture 224 and/or the welding horn 230 may include one or more forming features. The forming features of the fixture 224 may cooperate with corresponding forming features of the welding horn 230 during the ultrasonic welding process to form the insulating receptacle 100. More particularly, the forming features may be configured to form a welded seam 130 along the edges 123 of the blank 112 to produce the insulating receptacle 100. In one embodiment, the forming features on the fixture 224 may be a pair of spaced apart engagement/welding elements 240, 242. The engagement/welding elements 240, 242 may be configured to cooperate with a corresponding pair of spaced apart engagement/welding elements 244, 246 on the welding horn 230. In certain embodiments, a surface of each of the engagement/welding elements 240, 242, 244, 246 may be substantially smooth and uninterrupted. In other embodiments, each of the engagement/welding elements 240, 242 of the fixture 224 may include a one or more protuberances 248 (e.g., teeth, ribs, etc.) formed thereon, while a surface of each of the engagement/welding elements 244, 246 of the welding horn 230 may remain substantially smooth and uninterrupted. In other embodiments, a surface of each of the engagement/welding elements 240, 242 of the fixture 224 may remain substantially smooth and uninterrupted, while each of the engagement/welding elements 244, 246 of the welding horn 230 may include one or more protuberances 249 (e.g., teeth, ribs, etc.) formed thereon. In yet other embodiments, one or more of the engagement/welding elements 240, 242 of the fixture 224 and one or more of the engagement/welding elements 244, 246 may include the respective protuberances 248, 249 formed thereon. The protuberances 248 on the engagement/welding elements 240, 242 of the fixture 224 may be configured to cooperate with the corresponding protuberances 249 on the engagement/welding elements 244, 246 of the welding horn 230. Various sizes, shapes, configurations, number, and spacing of protuberances 248, 249 on each of the engagement/welding elements 240, 242, 244, 246 may be employed. As a non-limiting example, the protuberances 248, 249 on the engagement/welding elements 240, 242, 244, 246 may have a desired size, shape, configuration, number, and spacing so that a distance between each weld point, or a pitch thereof, of the welded seam 130 shown in FIGS. 3 and 4 is substantially equal, giving the same appearance as the sewn seam 12 shown in FIG. 1. In some instances, the distance between each of the protuberance (i.e., weld points) is about 2.5 mm. The distance between the protuberances may be critical to permit flexing of the welded seam 130 during insertion and holding of the container 50, while maintaining a strong bond between the sides 114, 115 of the blank 112. It should be appreciated, however, that the distance between each of the weld points may be constant or vary as desired.

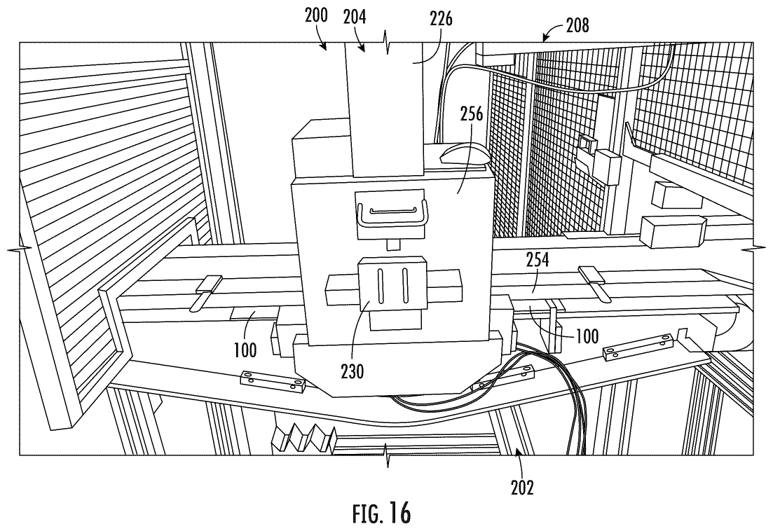

One or more guides 253 may also be provided on the fixture 224. The guides 253 may be configured to receive and direct a path of travel of the blank 112 through the welder 200. In some embodiments, the guides 253 receive and direct a carrier shuttle 254 (depicted in FIG. 16) that transports the blank 112 through the ultrasonic welding process. Various other means and methods of moving the blank 112 through the ultrasonic welding process may be employed if desired.

A protective enclosure 256 may be provided around at least a portion of the welder 200, as shown in FIG. 16, to militate against damage and harm to the welder 200 and/or the user.

Prior to the ultrasonic welding process, the bottom 116 of the blank 112 is folded upon itself to move the sides 114, 115 towards each other. In the folded position, the edge 123 of the side 114 of the blank 112 abuts and/or aligns with the respective edge 125 of the other side 115 and the edge 124 of the side 114 of the blank 112 abuts and/or aligns with the respective edge 126 of the side 115. The folded blank 112 is then positioned on the carrier shuttle 254 and transported to the welder 200 to commence the ultrasonic welding process.

During the ultrasonic welding process shown in FIG. 16, the carrier shuttle 254 with the folded blank 112 is received by the welder 200, and in some embodiments, positioned by the guides 253 of the fixture 224. When the folded blank 112 is in position for welding, the sides 114, 115 thereof are disposed between the forming features of the fixture 224. In certain embodiments, the sides 114, 115 of the folded blank 112 are located between the engagement/welding elements 240, 242 of the fixture 224 and the corresponding engagement/welding elements 244, 246 of the welding horn 230. The engagement/welding elements 240, 242 of the fixture 224 and the engagement/welding elements 244, 246 of the welding horn 230 are then moved towards each other to clamp the sides 114, 115 of the folded blank 112 therebetween. Thereafter, the converter converts an electrical signal supplied to the welder 200 into a mechanical vibration or ultrasonic energy. The booster then modifies an amplitude of the mechanical vibration/ultrasonic energy. The mechanical vibration/ultrasonic energy is then applied to the sides 114, 115 of the folded blank 112 by the welding horn 230. The mechanical vibration/ultrasonic energy generates heat at a joint interface of the blank 112, resulting in melting thereof and weld formation after cooling. As more clearly shown in FIG. 4, the welded seams 130 have a relatively low profile and/or present less impediment (e.g., bumps), resulting in easier insertion of the container 50 into the receptacle 100. The welded seams 130 may also be more visually appealing to the user.

Once the ultrasonic welding process is complete, the engagement/welding elements 240, 242 of the fixture 224 and the engagement/welding elements 244, 246 of the welding horn 230 are moved away from each other to unclamp the sides 114, 115 of the folded blank 112. Thereafter, the carrier shuttle 254 with the welded blank 112 is caused to exit from the welder 200 and, if available, a subsequent carrier shuttle 254 with a folded blank 112 is received therein. In certain instances, the ultrasonic welding process takes about one and a half (1.5) seconds and a total cycle time of about three (3.0) seconds per receptacle 100.

Advantages include, but are not limited to, ease of manufacturing, easy collapsibility, enhanced quality control, maximization of storage space, insulation of the container 50, militation against buildup of condensation, facilitation of grip on the container 50, and protection of a holder of the container 50 in the receptacle 100. Additionally, the ultrasonic welding process is simple, fast, produces consistent widths between seams, has relatively low maintenance costs, minimum labor requirements, no consumables, and produces a durable and relatively strong insulating receptacle 100 for the container 50.

Various details of the present disclosure maybe changed without departing from the scope of the present disclosure. Furthermore, the foregoing description of the preferred embodiments of the present disclosure and best mode for practicing the present disclosure are provided for the purpose of illustration only and not for the purpose of limitation, the present disclosure being defined by the claims.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A method of manufacturing an insulating receptacle, comprising:
providing a blank from one or more materials; and
ultrasonic welding the blank to form the insulating receptacle.

2. The method of claim 1, further comprising disposing an indicia on the blank prior to the ultrasonic welding of the blank.

3. The method of claim 1, wherein the blank is formed from at least one of a polyester weave material, a neoprene material, a foam material, a flexible material, a stretchy material, a liquid proof material, a liquid resistant material, and/or blends thereof.

4. The method of claim 1, wherein the blank includes a plurality of sides, each of the sides having one or more opposing edges.

5. The method of claim 4, further comprising aligning an edge of one of the sides and an edge of another one of the sides prior to the ultrasonic welding of the blank.

6. The method of claim 4, wherein the ultrasonic welding occurs adjacent the edges of the sides to join the sides together.

7. The method of claim 1, wherein the ultrasonic welding of the blank is by a welding machine, and wherein the welding machine includes a fixture and a drive system having a welding horn.

8. The method of claim 7, wherein the fixture and/or the welding horn includes one or more engagement/welding elements.

9. The method of claim 8, wherein the one or more engagement/welding elements of the fixture include one or more protuberances formed thereon.

10. The method of claim 9, wherein a distance between each of the protuberances is about 2.5 mm.

11. The method of claim 9, wherein the one or more protuberance is a plurality of teeth formed on the one or more engagement/welding elements of the fixture.

12. The method of claim 8, wherein the one or more engagement/welding elements of the welding horn include one or more protuberances formed thereon.

13. The method of claim 12, wherein a distance between each of the protuberances is about 2.5 mm.

14. The method of claim 12, wherein the one or more protuberance is a plurality of teeth formed on the one or more engagement/welding elements of the fixture.

15. The method of claim 1, further comprising transporting the blank by a carrier shuttle.

16. The method of claim 1, wherein the ultrasonic welding has a total cycle time of about three seconds per insulating receptacle.

17. A method of manufacturing an insulating receptacle, comprising:
providing a blank from one or more materials, wherein the blank includes opposing sides having one or more edges;
folding the blank to align the one or more edges of the sides;
disposing the folded blank into a carrier shuttle;
transporting the folded blank to a welding machine;
ultrasonic welding the folded blank adjacent the edges of the sides to form the insulating receptacle; and
transporting the welded blank from the welding machine.

18. The method of claim 17, further comprising disposing an indicia on the blank prior to transporting the folded blank to the welding machine.

19. An insulating receptacle, comprising:
a blank comprising at least one piece of material having opposing sides, wherein each of the sides includes one or more edges; and
an ultrasonic-welded seam adjacent each of the edges to form the insulating receptacle.

20. The insulating receptacle of claim 19, wherein an indicia is provided on the blank.
